(19) United States
(12) Patent Application Publication
(10) Pub. No.: US 2019/0190741 A1
(43) Pub. Date: Jun. 20, 2019

(54) BUILDING AUTOMATION SYSTEM WITH COMMISSIONING DEVICE

(71) Applicant: PHILIPS LIGHTING HOLDING B.V., Eindhoven (NL)

(72) Inventor: MATTHIAS WENDT, WÜRSELEN (DE)

(21) Appl. No.: 16/323,092

(22) PCT Filed: Jul. 24, 2017
(86) PCT No.: PCT/EP2017/068633

§ 371 Date: Feb. 4, 2019

(30) Foreign Application Priority Data
Aug. 5, 2016 (EP) 16182994.0

(51) Int. Cl. H04L 12/28; H05B 37/02; F24F 11/58

(52) U.S. Cl. CPC H04L 12/2809; H04L 12/2814; F24F 11/58; H05B 37/0272

(57) ABSTRACT

An electronic building automation system, comprising multiple electronic building automation devices and a commissioning device. The multiple electronic building automation devices comprising a beacon receiver arranged to receive localizing beacon signals transmitted from multiple beacons installed in the vicinity of the multiple building automation devices. The commissioning device being configured to localize a building automation device using the localization information in a beacon message received from the building automation device to obtain an estimated location of the building automation device to commission the building automation device in the building automation system.

### FIELD OF THE INVENTION

The invention relates to a building automation system, a commissioning device, a commissioning method, and a computer readable medium.

### BACKGROUND

In modern lighting systems the number of devices is growing. This is because of the wish for fine grained lighting but also because LED based lamps can be made efficient in ever smaller form factors and small lumen packets. As the complexity of such systems increases, commissioning the assets, e.g., the luminaires, the sensors, and switches becomes also more challenging.

Before a luminaire can be used in a connected lighting system is must be commissioned, e.g., incorporated in the network. Not only does a luminaire need network information, e.g., a network address and possibly other network parameters, but it must also form an operational part of the connected lighting system. For example, a load device needs to respond in the correct way to the environmental changes detected by trigger devices, e.g., occupancy sensors, light sensors and switches. For example, a trigger device may have to be configured to that it sends a trigger signal to the correct load device or control computer. For example, a load device may have to be configured to that it responds to a trigger signal sent by the correct trigger device or control computer.

Conventionally, the commissioning of a connected lighting network is done mostly manually. A commissioning operator might go from luminaire to luminaire and manually commission the luminaire and other assets of the connected lighting network. Connecting to the luminaires one by one, e.g., over Bluetooth, and commissioning the luminaires one by one. This requires a lot of work, and on-site presence of commissioning personal.

Reference is made to US patent application 2009/066473 A1, with title “Commissioning wireless network devices according to an installation plan”.

### SUMMARY OF THE INVENTION

An electronic building automation system is provided comprising multiple electronic building automation devices and a commissioning device. The multiple electronic building automation devices comprise:

a communication interface arranged to communicate with an external commissioning device over a digital network,

a beacon receiver arranged to receive localizing beacon signals transmitted from multiple beacons installed in the vicinity of the multiple building automation devices, a localizing beacon signal comprising a beacon identifier identifying the beacon from which the localizing beacon signal originated,

a beacon identifier memory for storing beacon identifiers received by the beacon receiver, and

a processor circuit configured to
generate a beacon message comprising localizing information based on the beacon identifiers stored in the beacon identifier memory,
transmit the beacon message to the external commissioning device over the digital network together with a network address identifying the building automation device in the digital network.

The commissioning device comprises:

a communication interface arranged to communicate with the multiple electronic building automation devices over the digital network, and receive a beacon message comprising localizing information based on the beacon identifiers received by the building automation device, together with a network address identifying the building automation device in the digital network, and

a processor circuit configured to
localize a building automation device using the localization information in a beacon message received from the building automation device to obtain an estimated location of the building automation device to commission the building automation device in the building automation system.

The inventor realized that automated commissioning at present is not possible since a commissioning device does not know where a building automating device is. The location is however important for the commissioning. For example, a luminaire in a bathroom may have to be assign to a control group that is controlled by an occupancy sensor. An office luminaire may use an occupancy sensor, but also a light sensor and a switch. After the commissioning the bathroom luminaire should respond to different stimuli than the office luminaire, in different ways.

Unfortunately, location information is not easy to come by. The network used in a connected lighting system does not always give accurate clues as to the location of a lighting asset. Even if the lighting system is wired, e.g., using Power over Ethernet technology, the routing of the network does not always give a good indication of the light network asset's location. Two elements that are close in the network, need not be close in physical distance. Even if two lamps are connected to the same switch they do not need to be near to each other or even be in the same room. The latter happens in practice because switches are relatively expensive elements in a connected lighting system, so that they tend to be used to capacity.

The same problem occurs not only in connected lighting systems, but more generally in the field of building automation. In building automation, multiple devices are connected through a digital network to control computer. The control computer manages the building automation system. Building automation includes heat, ventilation, air conditioning (HVAC), lighting, security, etc.

A network address may be any identifier of a device through which messages to the device can be addressed. For example, a building automation device may receive or be programmed with the network address; messages intended to be received at the device can be sent with the network address so that the correct device receives the message. For example, a network address may be recognized by a device in a stream of multiple message, so that it selects the messages addressed to the device. A network address may but need not be used to route messages in the network. For example, a network address may be an IP address. Other examples of network addresses are the MAC address. A network address may also be a name, e.g., the network name, or serial number that can be used to address messages. The name may be a resolvable name, such as an URL, that is translated to an IP address or the like, using a translation service, e.g., like DNS.

In an embodiment, the commissioning device comprises:
a map storage comprising a digital plan of the building automation system, the digital plan comprising multiple building automation device identifiers corresponding to the multiple building automation devices and a corresponding location, wherein
the processor circuit is configured to
   match the estimated location of the building automation device with a stored location in the digital plan, and associate the building automation device identifier corresponding to the stored location with a network address received from the building automation device with the beacon message.

Often the connected lighting system has been planned in advance. It is known where, what types of assets need to be installed, at least approximately. In this case it is desirable that a mapping can be established between the devices in the plan and the installed devices. After such a mapping has been established the devices can be controlled as planned, e.g., by automated rules.

Moreover, the plan increases the accuracy of the localization. Beacon based localization is relatively inaccurate. However, if the estimated location of a luminaire is near the planned location of a luminaire, it can be assumed that these are the same luminaire. In a sense the accuracy of the beacon based localization system has been increased by using the information in the digital plan.

In an embodiment, the map storage comprises a digital plan of the building automation system, the digital plan comprising the location of multiple control areas. In this case the plan does not necessarily need the location of individual building automation devices. An indication of which areas are to be controlled together, e.g. room, or part of rooms, is sufficient. In this embodiment, a digital plan with location of assets may be created automatically.

Furthermore, the processor circuit may be configured to
match the estimated location of the building automation device with a control area of the multiple control areas,
assign the building automation device matched to the same control area to at least one group of building automation devices associated with the control area. One or more control rules may be associated to the group of building automation devices.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code stored on a computer readable medium for performing a method according to the invention when said program product is executed on a computer.

In a preferred embodiment, the computer program comprises computer program code adapted to perform all the steps of a method according to the invention when the computer program is run on a computer. Preferably, the computer program is embodied on a computer readable medium.

Another aspect of the invention provides a method of making the computer program available for downloading. This aspect is used when the computer program is uploaded into, e.g., Apple's App Store, Google's Play Store, or Microsoft's Windows Store, and when the computer program is available for downloading from such a store.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1a schematically shows an example of an embodiment of a building automation system,

FIG. 1b schematically shows an example of an embodiment of a commissioning device,

FIG. 1c schematically shows an example of an embodiment of a building automation system,

FIG. 1d schematically shows an example of an embodiment of a building automation system,

FIG. 1e schematically shows an example of an embodiment of a building automation system,

FIG. 1f schematically shows an example of an embodiment of a building automation system,

FIG. 1g schematically shows an example of an embodiment of a building automation system,

FIG. 1h schematically shows an example of an embodiment of a building automation system,

FIG. 2a schematically shows an example of an embodiment of an office light plan

FIG. 2b schematically shows a detail of FIG. 2a,

FIG. 3 schematically shows an example of an embodiment of a library in a perspective view,

FIG. 4a schematically shows a detail of FIG. 2a,

FIG. 4b schematically shows an example of an embodiment of a beacon reception report,

FIG. 5 schematically shows an example of an embodiment of a building automation system,

FIG. 6a schematically shows an example of an embodiment of a handheld commissioning device,

FIG. 6b schematically shows an example of an embodiment of a handheld commissioning device,

FIG. 7a schematically shows an example of an embodiment of a commissioning method,

FIG. 7b schematically shows an example of an embodiment of a commissioning method,

FIG. 7c schematically shows an example of an embodiment of a commissioning method,

FIG. 8a schematically shows a computer readable medium having a writable part comprising a computer program according to an embodiment,

FIG. 8b schematically shows a representation of a processor system according to an embodiment.

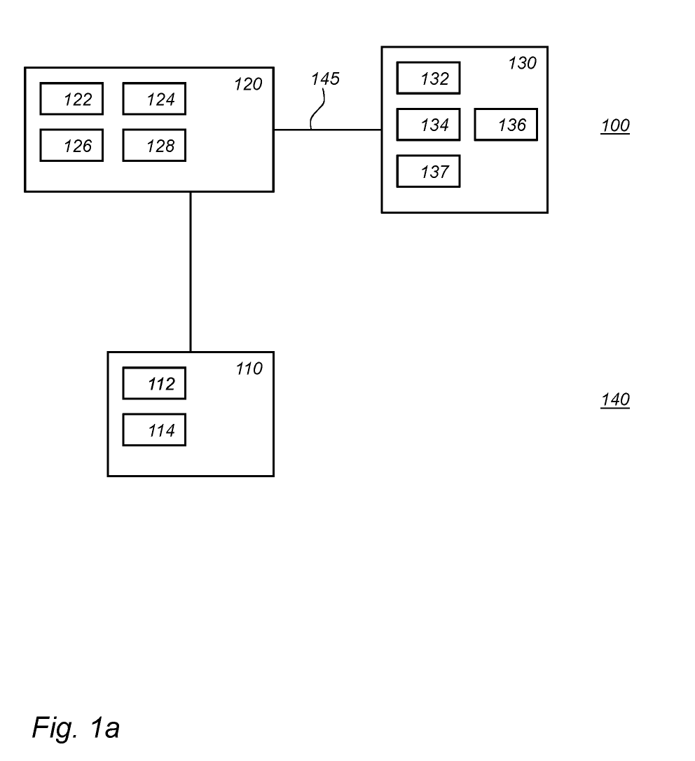

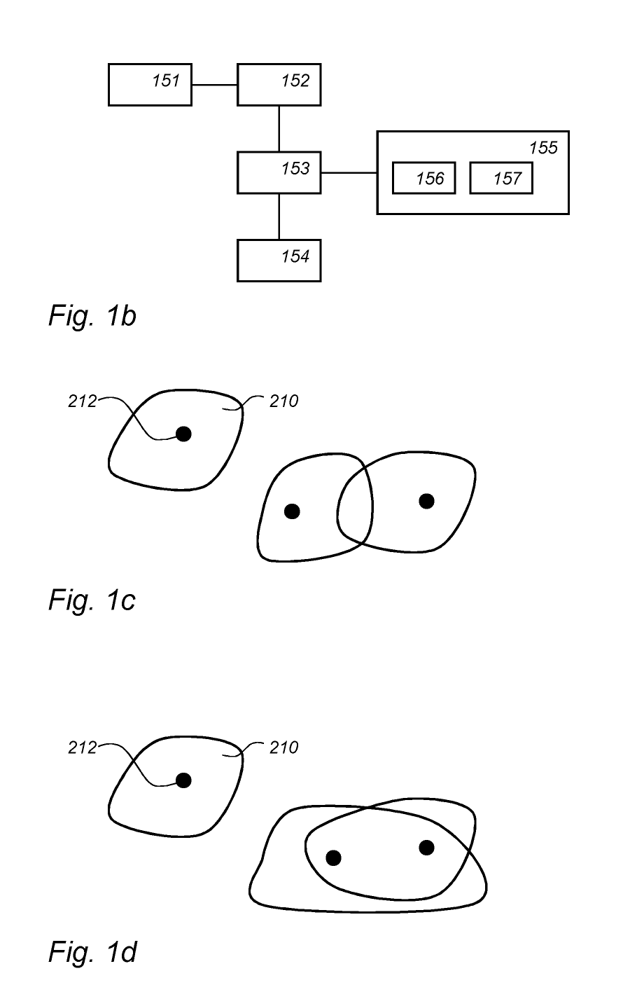

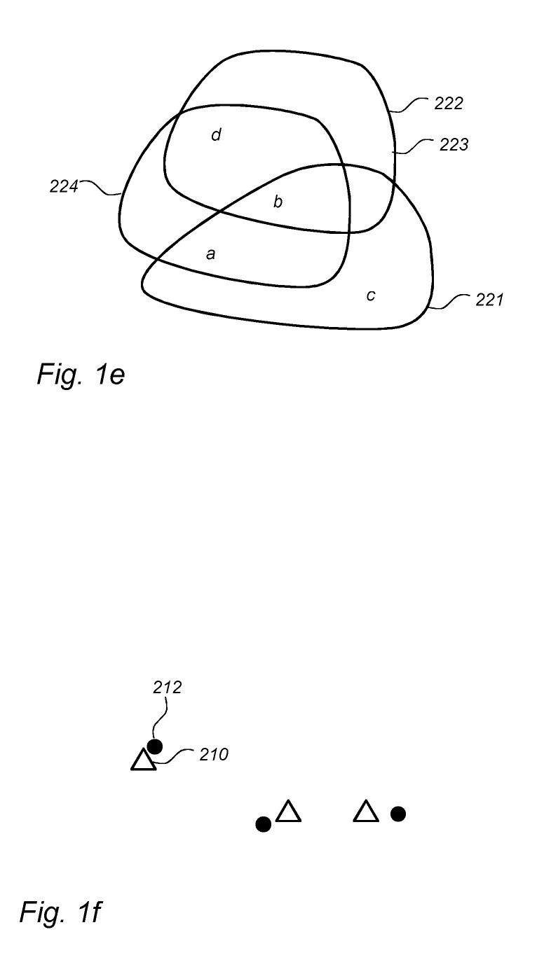

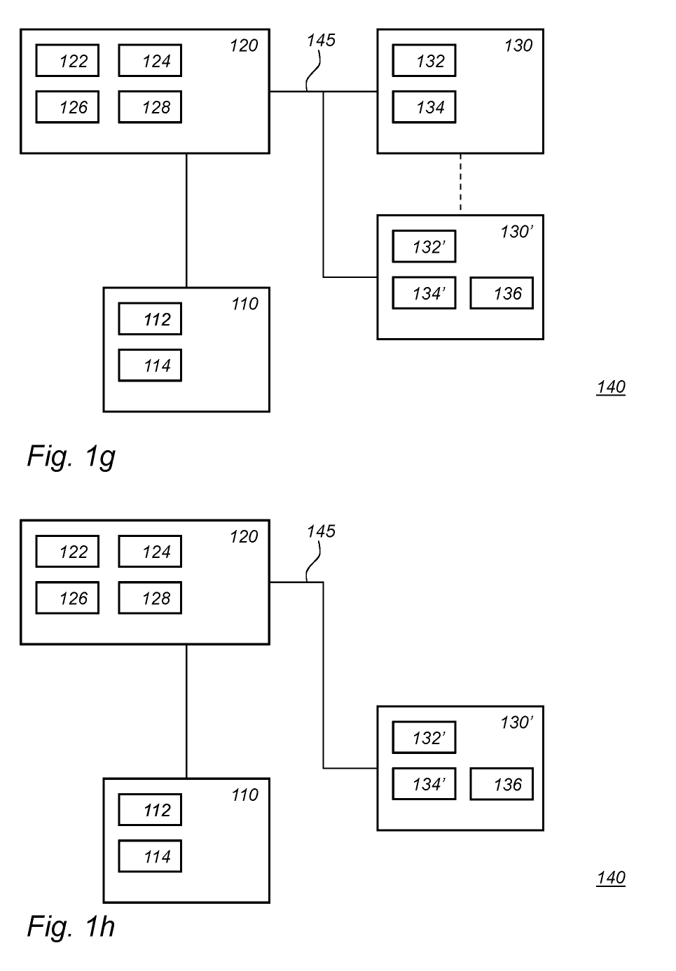

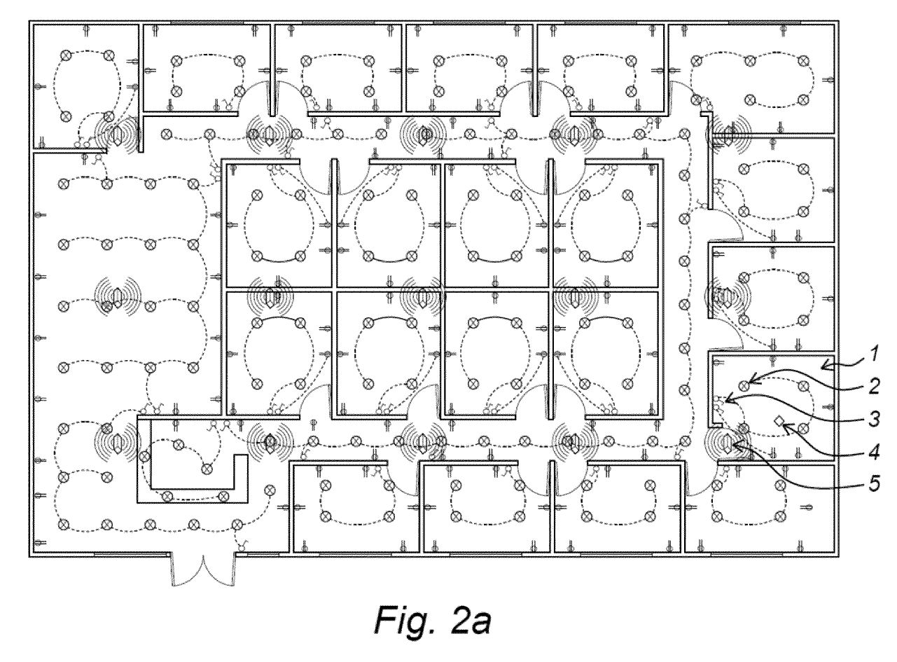

### LIST OF REFERENCE NUMERALS, IN FIGS. 1a-1g, AND 5

100 a building automation system
110 a beacon
112 a radio circuit
114 a beacon memory
120 an electronic building automation device
122 a communication interface
124 a beacon receiver
126 a beacon identifier memory
128 a processor circuit
130 a control computer
130′ a commissioning device
132, 132′ a communication interface
134, 134′ a processor circuit
136 a map storage
137 a rule database
140 a localization system
145 a digital network
151 known beacon locations
152 a localizing unit
153 a matching unit
154 an addressing table
155 a digital plan
156 locations of building automation devices
157 types of building automation devices
210 an estimated location
212 a location of a building automation device in a plan
221-224 an estimates location
a-d plan locations
510, 520 control areas
512, 522, 524, 526 an estimated location

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

FIG. 1a schematically shows an example of an embodiment of an electronic building automation system 100. System 100 comprises multiple electronic building automation devices. One building automation device 120 is shown. System 100 further comprises a control computer 130. Control computer 130 and the building automation device are connected via a digital network. Control computer 130 controls the building automation devices.

FIG. 1a further shows a localization system 140. Localization system 140 comprises multiple beacons. One beacon 110 is shown, the other beacons follow the same or a similar design. For example, the beacons may be distributed around a building.

Beacon 110 comprises a beacon memory 114. Beacon memory 114 is arranged to store a beacon identifier. In an embodiment, the beacon identifier is unique for localization system 140. Beacon 110 comprises a radio circuit 112. Radio circuit 112 is arranged to transmit a wireless localizing beacon signal. The wireless localizing beacon signal comprises the beacon identifier stored in beacon memory 112. Beacon 110 is arranged to periodically repeat the localization signal. Beacon 110 may comprise a processor circuit configured to generate the localization signal and to periodically repeat transmission of the localization signal over radio circuit 112. Radio circuit 112 may comprise an antenna.

Beacon based localization system 140 allows a device with a beacon receiver, e.g., a mobile phone, to obtain its position on a small scale. Beacon based localization system 140 is in particular suited where GPS reception is poor, e.g., indoors. The indoor location may be used, e.g., to deliver contextual content to users based on location. For example, information what is at a specific location may be obtained separately as a wireless service as requested by a mobile app. A localization system may be the backbone for many location-based services.

Beacons may be based on different types of wireless technology. For example, beacons 110 may be a Bluetooth, Zig-Bee, or Wi-Fi beacon. In an embodiment, beacon 110 uses Bluetooth Low Energy. Other possible beacon types include BLE, Wi-Fi, WiMAX, cellular triangulation or LoRa (e.g. for street lighting). The received beacons may be a mixture of different type beacons.

Beacons typically operate alone and may be battery powered which means they have to be serviced every couple of years. Typically, beacons are not part of a network, and are not able to send push-messages to receiving devices. Neither are beacons equipped for collecting user data or for storing these. In an embodiment, a beacon solely sends information about its identity. The beacon identifiers distinguish the beacons in localization system 140 from each other.

Often beacons are installed in a grid to give good location coverage over the whole space. Advantageously, beacons are placed in the ceiling. With this placement they are located with a good line of sight which is beneficial for reception coverage.

In further developed embodiments, beacon receivers are positioned at different heights to obtain increased resolution. Beacon receivers at different heights may be used to localize a beacon receiver in three dimensions. In a yet further developed embodiment, a beacon receiver comprises a directive antenna. A directive antenna allows determine a direction from which a beacon signal came. Having a direction in addition to a signal strength allows obtaining a more accurate position.

In an embodiment, a localization signal comprises a constant preamble followed by the beacon identifier. The beacon identifier may be a UUID (Universally Unique Identifier), and a Major and Minor value. For example, the UUID may be 16 bytes long, Major and Minor are each 2 bytes long. Together these form an ID for the beacon. In an embodiment, the UUID is the same for all beacons in the same localization system 140, while the Major and Minor values vary for each beacon. A localization signal may further comprise a signal power value. For example, it may represent the RSSI value (Received Signal Strength Indication) measured at 1 meter from the beacon. The value of this RSSI may be used in calculating a location from received signal strengths. The signal power value of the beacon may be known at the control computer. For example, the control computer may comprise a table associating beacon identifier to signal power value. The signal power value may be the same for all beacons in localization network 140.

The range of the localization signal of a beacon depends on the transmission power of the beacon. This may be the same for all beacons, or may be set differently for some beacons. Note that reception of a beacon localization signal depends on environmental factors. The localization signal is repeated each time period. The time period may be set smaller if frequent updates in localization are needed, e.g., if the localized object moves quickly. More frequent repeats of the localization signal use more power. For example, a repeat interval may be set between, e.g., 100 ms and 1 second, e.g., 200 ms.

Building automation device 120 comprises a communication interface 122 arranged to communicate with control computer 130 over a digital network 145. Digital network 145 may comprise a wired network, e.g., an Ethernet network, e.g. using one or more power over Ethernet connections (PoE). Digital network 145 may comprise a wireless network, e.g., a Wi-Fi or ZigBee network. Digital network 145 may combine wired and wireless technologies.

Building automation device 120 comprises a beacon receiver 124 arranged to receive localizing beacon signals transmitted from multiple beacons installed in the vicinity of the building automation device. From the received localizing beacon signals an estimate of the location of building automation device 120 may be computed. It is not necessary that all building automation devices in building automation system 100 comprise a beacon receiver 124.

Computing a location from received localizing beacon signals may be done in a variety of ways. For example, in a simple embodiment, one may simply conclude that the building automation device 120 is not too far removed from the beacons that it can receive, e.g., it is within range. In a more advanced embodiment, the intersection of the ranges of the received beacons may be determined, and it can be concluded that building automation device 120 is located in or near the intersection. Building automation device 120 comprises a beacon identifier memory 126 for storing beacon identifiers received by the beacon receiver in a time period. For example, device 120 may comprise a processor circuit configured for storing a received beacon identifier in beacon identifier memory 126.

In an embodiment, the beacon identifiers that are received in the localization signals are stored in the beacon identifier memory 126. In an embodiment, beacon identifier memory 126 is last in last out, e.g., a queue. For example, the beacon identifier memory 126 may be sized to store the last 100 beacon identifiers. In a smaller embodiment, beacon identifier memory 126 may keep only the last 4 beacon identifiers. In a more advanced embodiment, processor circuit 128 is configured to store for each received beacon identifier the time at which it was last received. In an embodiment, the time period for which information on beacon identifiers is kept may be limited to a specific value, e.g., to a few seconds, a minute, etc. For example, the latter may be implemented by discarding all beacon identifiers that were received more than the time interval ago.

In an embodiment, device 120 does not receive or process the localization signals continuously, e.g., to reduce power use, or bandwidth, or to reduce complexity. For example, device 120 may be configured to store beacon identifier only during a time interval of a specific length, e.g., a minute, a second, etc. This may be repeated, say, once or a few times a day.

Better estimates of location can be made by recording the received signal strength of the localization signal. In an embodiment, beacon receiver 124 is arranged to measure the signal strength of the localization signal. Processor circuit 128 is arranged to store a signal strength indication with the beacon identifiers in the beacon identifier memory. The signal strength indication indicates the signal strength with which the localization signal was received at beacon receiver 124. Optionally, processor circuit 128 is arranged to also store a signal power value received in the localization signal. The signal power value may be used with the signal strength indication in estimating a distance between the beacon receiver 124 and the beacon. The signal power value may also be used to verify that the settings of the beacons have not changed without authorization. The signal strength indication and optionally the signal power value may be communicated to control computer 130.

In an embodiment, a beacon receiver may be arranged to report a signal strength indication, e.g., RSSI. From the signal strength indication an estimated distance to the beacon may be computed. In an embodiment, the estimated distance may be rounded to a small number of categories, e.g., unknown, immediate below 50 cm, near up to 2 m and far up to 30 m.

Processor circuit 128 may be arranged to generate a message comprising beacon identifiers stored in the beacon identifier memory, and to transmit the message to control computer 130 over the digital network. The message may also include a signal strength indication, e.g., for each received beacon identifier. The received signal strength indication may, e.g., be expressed in decibels. For example, control computer 130 may comprise a communication interface 132 arranged to communicate with the building automation devices 120 over digital network 145. Control computer 130 comprises a processor circuit 134 configured to process the received messages.

From the information on the received beacon identifier, and possibly the signal strength indication, and known locations of the beacons, a location of the beacon receiver can be estimated using various algorithms known in the art. For example, a trilateral estimation may be used, comprising estimated the distance between the beacon receiver and at least 3 beacons using the received signal strength. An example is given in the paper “Algorithms for Location Estimation Based on RSSI Sampling”, by Papamanthou et al.

In an embodiment, building automation device 120 is a luminaire. In an embodiment, building automation device 120 is any one of the following group: a heating device, a ventilation device, an air conditioning device, a speaker, an automated air valve, a fire detector, a sensor, a wall switch. For example, the control computer may be a back-end of a building automation system (BAS) or building management system (BMS).

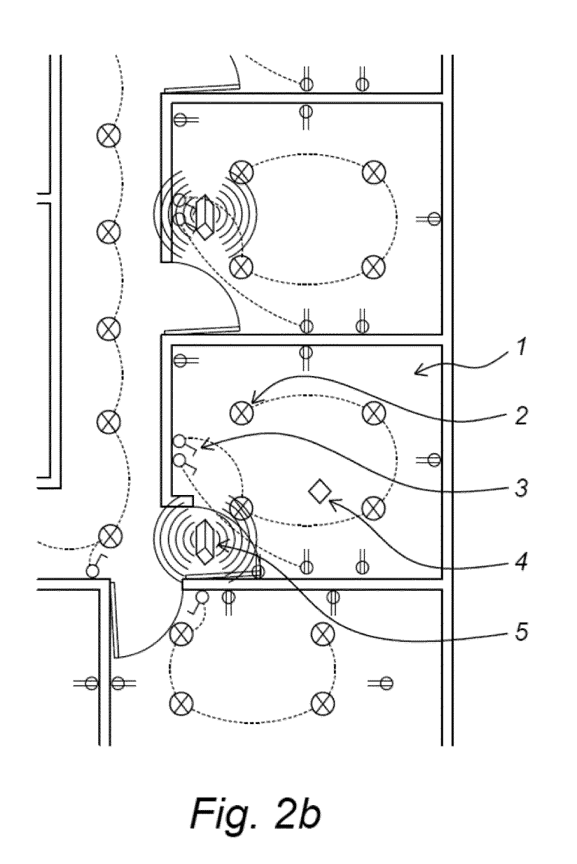

FIG. 2a schematically shows an example of an embodiment of a digital plan, in this case an office light plan. FIG. 2b schematically shows a detail of FIG. 2a. A connected lighting system is an example of a building automation system. Shown in FIGS. 2a and 2b are beacons 5, arranged in a grid. For example, the lighting plan shown in FIG. 2a may be an office space comprising a number of office rooms 1. In the office room 1, a group of lamps 2 are controlled by manual switches 3 and/or sensors 4. In embodiment, one or more of the assets like sensors 4, manual controls 3 and light sources 2 comprise a beacon receiver as shown in FIG. 1a. The connected lighting system of FIG. 2a comprises a control computer, which is not shown in FIG. 2a.

In an embodiment, sensor 4 is an occupancy sensor arranged to determine occupancy of an area surrounding the occupancy sensor. For example, the occupancy sensor may be an infrared sensor, or a movement sensor, etc. For example, the occupancy sensor is arranged to generate an occupancy signal if the occupancy sensor detects occupancy or no occupancy of an area surrounding the occupancy sensor. The occupancy signal may be used to control the luminaires 2. This may be done directly, e.g., by a local network of a local network, or via the control computer. For example, processor circuit 134 of control computer 130 may be configured to determine from one or more occupancy sensors an occupancy status of an area surrounding the luminaire 2, e.g., office 1. If control computer 130 determines that office 1 is occupied, then control computer may send a control message to the luminaires 2 to switch them on. Possibly, the decision to turn a luminaire on may be more complicated and also involve day light sensors, and (wall) switches or other local controls, time of the day, etc.

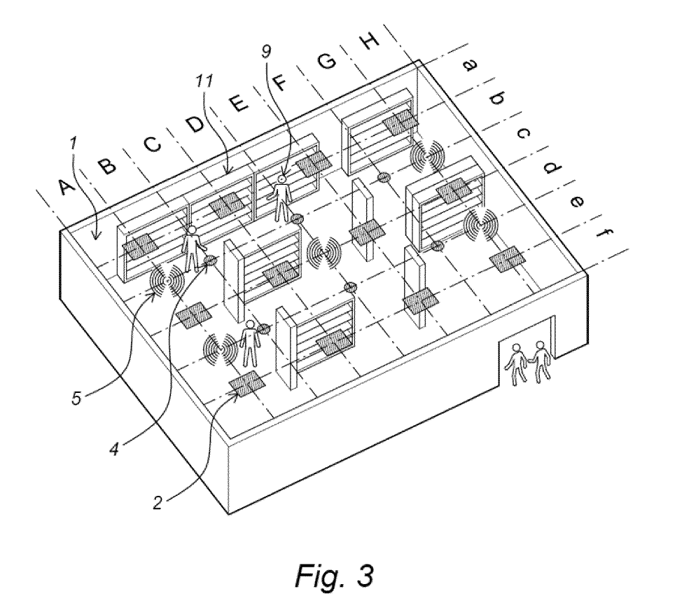

FIG. 3 schematically shows an example of an embodiment of a library in a perspective view. Here beacon technology is used to support people searching for specific books by means of multiple beacons 5 installed in the ceiling distributed over the space. FIG. 3 shows a room 1 with a grid of light sources 2 in the ceiling and five beacons 5. People 9 are moving around and are supported to reach a shelf 11 where a certain book is located. For example, a mobile phone of people 9 may comprise a beacon receiver to determine a location in the library. Using the location of the mobile phone a signal may be computed to guide the people in the correct direction. For example, the signal could be a map in which the desired location and the current location of the mobile phone are indicated. Similar applications are in shops, storing spaces or magazines.

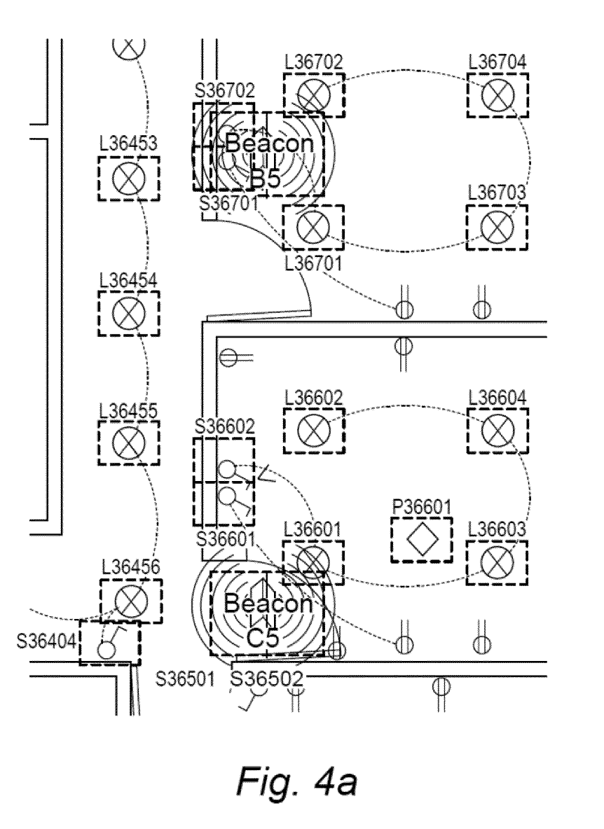

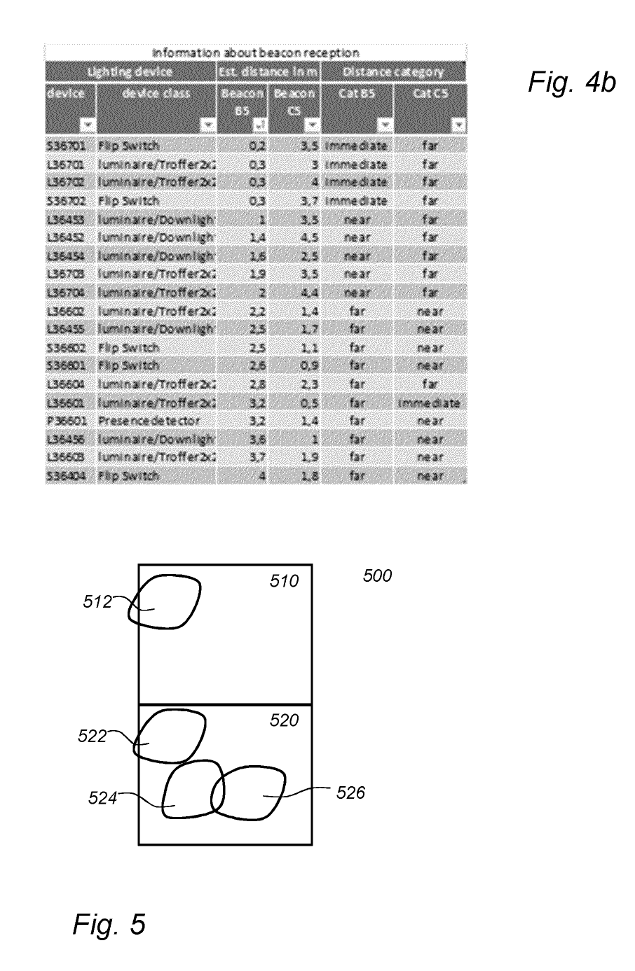

FIG. 4a schematically shows a detail of FIG. 2a. Shown in FIG. 4a are identifier of the assets in the building automation system, in this case a connected lighting system. Also shown are two beacons: B5 and C5. The assets are configured to send a message to control computer 130 with the received beacon identifiers and the corresponding signal strength indications. FIG. 4b schematically shows an example of an embodiment of a beacon reception report. Shown in FIG. 4b is a table with 6 columns: the identifier of the device in the lighting system, a device class, e.g., a device type, device model, etc., estimated distances to beacons B5 and C5, and estimated distance categories to beacons B5 and C5. The estimated distance to a beacon is often subject to a lot of noise, e.g., due to environment interference. In some applications the distance category is about as accurate as the estimate distance. For example, presence detector (occupancy sensor) P36601 is far from beacon B5 but close to beacon C5.

When a building automation device is commissioned it is integrated in the building automation system so that it responds to trigger signals (e.g., as a load device) or so that other building automation devices respond to trigger signals which it produces (e.g., as a trigger device). Control may be exerted in different forms.

First of all, trigger devices, e.g., day light sensors, wall switches, occupancy sensors, etc., e.g., devices that detect changes in the environment, may broadcast their trigger signal. Load devices, such as a luminaire, heating device, etc., or any other device that consumes energy to bring about a change in the environment, may be configured to receive the trigger signals from the network. The load device is configured with a rule which triggers if trigger signals are received from a particular trigger device. For example, a luminaire may store a rule, that it should switch on if it receives a switch-on trigger signal from a switch with a particular identifier, or network address. For example, a load device may comprise a list of trigger device ID's, or trigger addresses etc., from which the load device accepts commands, e.g., a flip command.

Second, a trigger device may send a control message addressed at a particular load device indicating that it should perform some action. For example, a switch may store a rule which causes a switch-on message to be sent to a particular luminaire, if the switch is turned on. For example, a trigger device may comprise a list of load device ID's, or load addresses etc., to which the trigger device sends commands, e.g., a flip command. In this case the load device may be configured to accept commands from all trigger devices.

For example, in the first case, rules are stored in the load device, in the second case rules are stored in the trigger device.

Third, trigger devices may send trigger signals to a control computer. The control computer stores rules that determine to which load devices a control message should be sent in dependence on a trigger signal received at the control computer. For example, the control computer, may receive a switch-on trigger from a trigger device, the control computer has a rule that determines which luminaire is to be switched on, and the control computer sends a control message to the luminaire. In most of the embodiments, we will assume that there is a control computer. This simplifies the discussion, however, these embodiments can easily be modified to work without a control computer. A control computer can support complex rules, e.g., that regulate load devices in dependence on multiple trigger devices. The additional cost of a control computer is sometime undesirable, though. In an embodiment, a control computer may be integrated with a switch, e.g., in the form of a wall panel.

For example, a temporary commissioning device may be used. The commissioning device may upload rules, and/or addressing information to the load devices (according to the first option), to the trigger device (according to the second option) or to a control device (according to the third option). Once all building automation devices are commissioned, or re-commissioned in case of replacements, the commissioning device may be removed from the network. In fact, even the beacons could be removed from the network, if they are only used for commissioning.

Although, most commissioning devices will be described as part of a control computer, the commissioning device may easily be separated from the control computer.

Having localizing information available from a building automation device which is to be commissioned in a building automation device can be used in many ways.

For example, a digital plan may be available with the locations of all lighting assets. The problem is, when the system is turned on for the first time, many messages are received at the commissioning device, but it has no idea which is which. There is a need to establish a link between the assets in the digital plan and the assets in the field. This can be used for new systems as well as for replacing parts of it. Once the link between the digital plan and the network addresses are established, rules can be enforced, e.g., according to any of the above three options.

In another example, there might not be a digital plan that has the location of all assets. Only the locations of the beacons are known. Furthermore, control areas are indicated in which assets are to cooperate, e.g., operated in the same manner. For example, the plan may indicate the rooms in the buildings, e.g., by indicating the walls. The rooms may be taken as control areas. In embodiments of connected lighting systems for example, all lights in a control area are operated simultaneously, e.g., all lights go on and off together in a meeting room. When the system is turned on for the first time, the commissioning device may create a digital plan with the locations of all lighting assets. A similar digital plan is obtained as above, but without the need to manually specify the location of all assets. If desired, the commissioning device may assign unique building automation device identifiers to the building automation device, e.g., sequentially, or randomly, etc.

Returning to FIG. 1a. We will first discuss embodiments in which an automatic link is established between identifiers of building automation devices in the plan, and network addresses received from the connected building automation system.

The building automation system comprises multiple electronic building automation devices 120 connected via digital network. During normal operation the building automation devices may send each other control messages over the digital network. There may also be a central control computer which controls the building automation devices. The latter option is shown in FIG. 1a.

When the building automation devices power-up in the network they obtain the necessary information to send and receive messages over the network. For example, the building automation devices may perform the Dynamic Host Configuration Protocol (DHCP), e.g., as specified in RFC 2131. The Dynamic Host Configuration Protocol is a network protocol used on Internet Protocol (IP) networks for dynamically distributing network configuration parameters, such as IP addresses. With DHCP, a building automation device requests an IP address and/or networking parameters from a DHCP server.

An IP address is an example of a network address identifying the building automation device in the digital network. Instead of using a network protocol for obtaining a network address, such as DHCP, the building automation device could be pre-programmed with a network address, e.g., an IP address. The building automation device may also or instead have a media access control address (MAC address). MAC addresses may also be used as a network address. A network address may also be a name, such as an URL, that is translated to an IP address or the like, using a translation service, e.g., like DNS. Once the building automation device has obtained a network address, it can send and receive messages to and from control computer 130 and/or the other building automation devices that are on the same digital network. For full operation in a connected building automation system, it is however not sufficient that a building automation device is addressable. The building automation device needs to be controlled in the right manner, in dependence upon the environment.

A commissioning device may be used to integrate a building automation device into a building automation system. A control computer may act as the commissioning device. If a control computer, like control computer 130 is used, this computer may perform the task of commissioning in addition to controlling the building automation network. This option is shown in FIG. 1a. FIG. 1g show an embodiment in which a control computer and a separate commissioning device are used. FIG. 1h shows an embodiment in which no separate control computer is used, only a commissioning device. In this case, the commissioning device may configure the load and trigger device to respond to each other correctly, without an intermediate control computer.

The building automation devices are configured to send a beacon message comprising beacon identifiers received with a beacon receiver of the building automation device. For example, a building automation device may be configured as follows. Upon power-up it obtains a network address, e.g., by performing a network protocol. Next, it sends a beacon message together with the network address to the commissioning device, e.g., control computer 130 acting as commissioning device. In an embodiment, building automation device 120 may have memory to store if it has been commissioned already. In that case, the beacon message may, e.g., only be sent out if the building automation device has not yet been commissioned. For example, in an embodiment, the building automation device may store a building automation device identifier, that it received from the commissioning device. If such an identifier has been provided, the building automation device may, e.g., send a message to the control computer comprising the building automation device identifier and the network address. This allows the IP address to change frequently without the need to re-do commissioning.

In an embodiment, the building automation devices include received beacon identifiers in the beacon message, preferably also including the received signal strength. In an embodiment the beacon message comprises localization information that may not directly comprise beacon identifiers. For example, the building automation device may contact a localization service, e.g., though the network, e.g., from a localization service providing computer. In this case, the localization information may directly include information on the location of the building automation device, e.g., coordinates, etc. This latter option is useful, for example, when third party beacon services are integrated with a connected lighting system, wherein no low-level access is available to third-party developers to information such as received beacon identifiers, but only have an API which gives processed information, such as an estimated location.

Control computer 130 comprises a communication interface 132 which is arranged to communicate with the multiple electronic building automation devices over the digital network. Control computer 130 receives the beacon message comprising beacon identifiers from a building automation device 120 together with its network address.

Control computer 130 comprises a map memory comprising a digital plan of the building automation system. FIG. 2a shows a graphical representation of a plan of a building automation system; in this case a connected lighting network. Typically, the plan indicates the location of the assets of the building automation system, e.g., switches, such as wall switches, sensors, and luminaires, etc., or HVAC devices etc. The plan may or may not include the actual wiring of the network (if a wired network is used). The devices in the plan have a device identifier. At least initially, this device identifier is often not available in the building automation devices, complicating the link between the plan and the devices. When a message is sent to a building automation device with a particular network address, there is a need to know to which building automation device in the plan this corresponds. For example, consider FIG. 4a in which examples of identifiers of building automation devices are shown.

Note that the plans in FIGS. 2a, 2b, 4a already contain a binding indication as a dashed line going from the wall switch to the related lamp. Such drawings are used in conventional wired commissioning and may be used as a basis to generate commissioning rules. For example, the binding indications may be used to derive control groups. However, embodiments of commissioning devices according to the invention do not need this binding indication.

The plan may also include rules on how the building automation devices are to react to the environment, as further detailed below.

Control computer 130 comprises a processor circuit 134 arranged to establish an association between a network address as received with a beacon message and a building automation device identifier as used in the digital plan. For example, processor circuit 134 may execute software stored at control computer 130. In an embodiment, the software has an architecture as indicated in FIG. 1b. FIG. 1b shows a localizing unit 152. Localizing unit 152 is configured to localize a building automation device using beacon identifiers in a beacon message received from the building automation device to obtain an estimated location of the building automation device.

In an embodiment, the building automation devices are configured to automatically send a beacon message, e.g., by broadcasting a beacon message. For example, the device may periodically broadcast a beacon message until it is commissioned. For example, a building automation device may receive a commissioning message which indicates that commissioning is complete. The commissioning message may comprise additional network information, e.g., security codes and the like. The commissioning message may comprise information, e.g., rules for operating the device, e.g., to send or receive and react to trigger signals. However, this is not necessary, a commissioning message may simply indicate that the device has been registered and indicate that it can stop broadcasting beacon messages.

In an embodiment, the commissioning message deactivates the broadcasting of beacon messages. This allows the commissioning device to immediately establish which remaining devices that are still broadcasting have not been commissioned yet. In this way a missing device, is highlighted.

In an embodiment, the control computer may call each device for the beacon identifiers received and in this way localize the assets and compare these to the locations as contained in a lighting plan. For example, the control computer may broadcast these request. For example, the control computer may receive the current network addresses of the building automation device from a DHCP server.

For example, localizing unit 152 may use known beacon locations 151. The known beacon locations may also be stored at the control computer. Localizing unit may perform the localizing computation on a different computer, e.g., in the cloud. As pointed out, there are several localizing algorithms. For example, for each of the beacon identifiers in the beacon message, an area may be constructed in which the beacon identifiers may be receivable, e.g., receivable with the observed RSSI. The intersection of the area's is an area in which the building automation device is likely to be. A digital representation of such an area may be used as the estimation of the location. An estimated location may also be a point, e.g., in coordinates, e.g., a center point of a likely area. More advanced algorithms may assign different probabilities to different points.

Control computer 130 may further comprise a matching unit 153. Matching unit 153 is configured to match the estimated location of the building automation device with a stored location in the digital plan. For example, matching unit 153 may use a digital plan 155. Digital plan 155 may comprise locations 156 of building automation devices.

Associated with the estimated location is the network address that came with the beacon message. Associated with the location in plan 155 is the building automation device identifier. Once the estimated location and the location in plan 155 have been matched together, the network address and the building automation device identifier can also be associated together. Matcher 153 stores the association between a building automation device identifier and a network address in an addressing table 154.

FIG. 1c illustrates a possible matching. In FIGS. 1c, 1d, 1f, the location of building automation devices in the plan (the ‘plan locations’) have been illustrated with a large black dot. One such plan location of a building automation device has reference numeral 212. In an embodiment, a plan in a map storage need not be graphic, a plan location may, e.g., by indicated with location data such as coordinates, grid references, etc. In this embodiment, localizer unit 152 estimates the location of building automation device 212 as an area. These areas are indicated in FIG. 1b. The area estimated for building automation device 212 has the numeral 210. Matching unit 153 assigns estimated location 210 to building automation device 212, e.g., because the latter is the only building automation device in the estimated location 210.

The other two estimated locations shown in FIG. 1c overlap somewhat. Nevertheless, a match is possible, as neither of the building automation device lie in the estimated area of the other building automation device. FIG. 1d shows a situation in which two estimated locations, here two areas, each includes two building automation device. Although the certainty with which the building automation device can be assigned reduces, it is still possible to match an estimated location with a known location in the plan. If multiple plan-locations of building automation devices can be associated to multiple estimated locations, there are several ways to break the ties. First of all, it is preferred that a selection is made that assigns one plan-locations to one estimated location. This may be done for example, by having the matching unit use a matching algorithm, e.g., based on Hall's marriage theorem, that selects a one-to-one assignment even if multiple combinations are possible. Although there is the possibility that some of the assignments are in error and must be manually corrected, this is much preferred to a situation in which no such selection is made, and the entire association must be done by hand. In an embodiment, the commissioning tool asks for confirmation, or verification of uncertain cases. For example, the commissioning tool may evaluate a certainty function which produces a measure indicating the uncertainty of the match. For example, the measure may increase with uncertainty increasing factors, such as indicating herein, e.g., multiple plan locations lying in or close to an estimated location and/or decrease with uncertainty decreasing factors, e.g., types, as explained below. If the uncertainty function exceeds a function for a building automation device, the user may be asked to verify or enter the mapping.

For example, FIG. 1e, shows four estimated locations: 221, 222, 223 and 224 (estimated locations 222 and 223 are identical). The figure also shows the plan location of four building automation device taken from the digital plan. These are marked: a, b, c, d. We have the following possibilities for a mapping between estimated locations and plan locations:

| | Possible |
|---|---|
| Estimated | plan |
| Location | location |
| 221 | a, b, c |
| 222 | b, d |
| 223 | b, d |
| 224 | a, b, d |

In this case, the matching unit can assign both 222 and 223 to any one of plan locations b and d, with a risk that this assignment may be wrong. However, 221 may be assigned to c, and 224 to a with a higher degree of certainty, as this is the only assignment that allows a one-to-one mapping. In this case, the mapping may be found by applying a Hall-based matching unit.

| Estimated | Possible plan location after |
|---|---|
| Location | matching |
| 221 | c |
| 222 | b |
| 223 | d |
| 224 | a |

The matching unit may give a warning signal, e.g., a report, an email, visual warning, etc., if a one-to-one mapping is not possible. For example, if two estimated locations can only match with plan location. For example, if the number of estimated locations is larger than the number of plan locations, etc. This may happen if there is a discrepancy between the plan and the connected lighting network that was installed. For example, an additional luminaire may have been installed that was not planned. In an embodiment, the commissioning device can generate a likely estimated location where the errand building automation device is located. For example, in the case where a number of estimated locations (say 2) can only match with a smaller number of plan locations (say 1), then the warning signal may include the estimated locations.

Figure if shows a situation in which the estimated location is not a region but a point. The estimated locations are indicated with a triangle. This case may be converted to the previous cases, by assigning an uncertainty region around the estimated location, e.g., a circle with a radius equal to a default uncertainty distance. Alternatively, the matching may directly be done on the points, e.g., by assigning an estimated location to the nearest plan location. If no such mapping is possible, the matching unit may be match to the second nearest plan location, and so on. The matching unit may minimize the number of matchings with second or higher nearest plan locations, e.g., by applying a weight to the quality of a matching, and optimizing the summed quality of all individual matchings. For example, the matching unit may minimize an error function of the distances between a planned location and an estimated location associated therewith. The function may be the sum, or the sum of squares, etc.

In an embodiment, matching unit 153 is configured to store an addressing table associating multiple building automation device identifiers and the associated network addresses of building automation devices. For example, continuing the example of FIG. 1e. The plan may comprise the following information:

| Building automation identifier | Plan Location |
|---|---|
| ID_a | a |
| ID_b | b |
| ID_c | c |
| ID_d | d |

The localizer may obtain the following information from beacon messages:

| Network address | Estimated Location |
|---|---|
| Addr_1 | 221 |
| Addr_2 | 222 |
| Addr_3 | 223 |
| Addr_4 | 224 |

Finally, in an embodiment the matching unit establishes a one-on-one mapping between the estimated locations and the plan locations, as indicated above. Matching unit 153 can no write an addressing table 154 as follows:

| Building automation identifier | Network address |
|---|---|
| ID_c | Addr_1 |
| ID_b | Addr_2 |
| ID_d | Addr_3 |
| ID_a | Addr_4 |

In an embodiment, matching unit 153 unit may use additional information to perform the matching.

In an embodiment, the addressing table may already be partially filled. This may happen, for example, in replacements. For example, a single or multiple building automation device may be replaced, e.g., because they are broken, as an update, as maintenance, etc.

For example, suppose the following addressing table is in place:

| Building automation identifier | Network address |
|---|---|
| ID_c | Addr_1 |
| ID_b | Addr_2 |
| ID_d | -open- |
| ID_a | Addr_4 |

For example, such an addressing table may be obtained by matching a network as in FIG. 1e. However, ID_d has no network address. The network address is open, e.g., because it has been removed. For example, it may be removed, as it is known that the device at location d is to be serviced. For example, it may be removed automatically, since the previous network address fails to send information, etc. When a beacon message is received which gives an estimated location like 222, then the matching unit may deduce that this should correspond to location d, since location b is already assigned. In an embodiment, the matching unit may be configured to match the estimated location of the building automation device with a stored location in the digital plan for which the corresponding building automation device identifier is not yet associated with a network address in the addressing table.

In an embodiment, the addressing information may be contained in a computer readable plan and may be used for the commissioning after an asset is identified by means of received beacons.

In an embodiment, the commissioning device may be configured to retrieve settings of the replaced building automation device, and sent a recommissioning message comprising the retrieved settings to the building automation devices from which the beacon message, e.g., a recommissioning request, originated. The setting may be, e.g., a rule for responding to trigger signals, or a rule for sending trigger signal to the correct device. The setting may also include the building automation device identifier.

In an embodiment, multiple luminaires or lighting elements, say TLEDs, are removed in one go, say, in the ceiling without powering up the ceiling in between. Beacons may be used to identify which factory-new TLED is (most likely) replacing which of the TLEDs from the initial TLEDs. The replacement TLEDs then are auto-commissioned with the right network and lighting control setting and join the lighting control system.

In an embodiment, the beacon message comprises a building automation device type of the building automation device. For example, the building automation device may be configured with the information that it is a ‘Flip Switch’ type building automation device. The digital plan may also comprise multiple building automation device types 157 associated with the multiple building automation device identifiers. For example, the digital plan may contain the following information:

| Building automation identifier | Plan Location | Type |
|---|---|---|
| ID_a | a | Troffer |
| ID_b | b | Troffer |
| ID_c | c | Downlight |
| ID_d | d | Flip Switch |

The beacon messages received also comprise an indication of the type of building automation device. For example, if a beacon messages are received from Addr_2 with the additional information that the building automation device is a Troffer, and from Addr_3 with the additional information that the building automation device is a Flip Switch, then matching unit 153 will arrive at only one possible mapping between building automation identifiers and network addresses. In an embodiment, matching unit 153 is configured to match the estimated location of the building automation device with a stored location in the digital plan for which the building automation device type associated with the corresponding building automation device identifier matches the building automation device type in the received beacon message. The second column of FIG. 4b shows a number of types in a connected lighting system.

The inventor found that even with the limited accuracy of beacon based localization systems the mappings produced by matching unit 153 are surprisingly accurate; especially when additional information such as types or partial addressing tables is used to supplement the location information. In those cases, in which the assignment is wrong, these are often luminaires in the same room which are to be controlled together. As such luminaires are operated together anyway, it has no impact on the system if some of these building automation devices are mixed up. For HVAC devices, the combination of the fact that these devices are typically further apart than luminaires and optionally the use of types gives good results.

Nevertheless, in some cases it is desired to correct the mapping. For example, it sometimes happens that a downlight in front of a whiteboard is confused with another downlight in the same room. For most downlights in the same room this would not matter, as they are typically operated together, but downlights in front of a whiteboard are sometimes assigned to group forming a control area in front of the white board. In this case, a wrong assignment may result in incorrect lamps dimming or lighting up when a presentation is given. To correct this, the commissioning device may comprise a user interface to change the relationship between building automation device identifiers and network addresses.

In an embodiment, control computer 130 comprises a rule database 137 comprising one or more rules. A rule indicates a status change for a load device in dependence on a trigger signal of a trigger device. For example, continuing the example of FIG. 1e. A rule may specify that if flip switch ID_d is switched the lighting status of Troffers ID_a and ID_b should be switched.

Commissioning device 130, e.g. matching unit 153 may identify a rule in the rule database applicable to a load and/or trigger device for which a network address has been received. For example, in this case, troffers ID_a and ID_b are load devices, whereas flip switch ID_d is a trigger device. Network addresses are available for all devices that are comprised in the rule.

The rule may now be sent to the load device, the trigger device or to a control device (if the control device is different from the commissioning device) depending on how control is organized in the system. For example, a message may be sent to trigger device ID_d instructing it to send a flip command to Addr_1 and Addr_2 it the trigger action (pressing the switch) happens. Alternatively, a message may be sent to load device ID_a and ID_b to instruct them to flip lighting status if they receive a message from Addr_3. The address may, e.g., be the IP address or a network name, etc.

During commissioning the commissioning device may also send building automation device identifiers to the building automation devices. In an embodiment, these identifiers are used in the rules which are uploaded to the load or trigger devices.

The rules may also be made available, e.g., sent to, on a control computer. In an embodiment, the control computer comprises rule database 137. Processor circuit 134 may be configured to
receive one or more a trigger signals of a trigger device,
determine that a rule in the rule database indicates a status change for a load device with a load identifier in dependence on the received trigger signals
determine the network address for the load identifier from the addressing table,
sent a command message to effect the status change for the load device to the network address determined for the load device identifier.

In this, the control computer received trigger signals from trigger devices throughout the building, and computes which load devices should be modified. In this case the trigger signals and command messages may be addressed instead of broadcasts which reduced network load.

Below an example of rules are given. Consider that there are lamps in a bath room connected to an occupancy detector and a wall switch. The lighting devices are listed with an automatically given IP addresses, e.g. using DHCP.

| Device | Device class | IP Address |
|---|---|---|
| P36601 | Occupancy sensor | IP_1 |
| P36602 | Occupancy sensor | IP_2 |
| S36702 | Flip Switch | IP_3 |
| L36453 | luminaire/Downlight | IP_4 |
| L36452 | luminaire/Downlight | IP_5 |
| L36454 | luminaire/Downlight | IP_6 |
| S39002 | Central Switch | IP_7 |

Light sources need to know on which triggers they have to switch on and on which to switch off. The rule for all bathroom downlights (L36452, L36453 L36454) could be:

1. Switch on whenever one of Occupancy sensors (P36601; P36602) or Flip Switch (S36702) is triggered.
2. Switch off whenever Flip Switch (S36702) is triggered or after time on since last occupancy signal is 30 seconds.
3. Switch off whenever Central Switch (S39002) is set to off

In systems with a name server the rule can be device name oriented, it is however easier to directly store the related IP addresses in the rules. In this case, the rules could conveniently be stored in the luminaires, or in a control computer.

FIG. 1g shows an embodiment in which the control computer 130 and commissioning device 130′ are separate. For example, commissioning device may perform commissioning, e.g., establishing an addressing table. Control computer 130 may be restricted to executing the rules.

FIG. 1h shows an embodiment in which no control computer 130 is used, only a commissioning device 130′. For example, commissioning device may perform commissioning, e.g., establishing an addressing table and uploading of rules to load and/or trigger devices.

FIG. 5 schematically illustrates a building showing two rooms 510 and 520.

Below an embodiment is described, with reference to FIG. 5, which may be used if no location of some or all building automation devices are known. These embodiments may or may not be combined with the previous embodiments. The inventor proposes to use devices which are able to receive beacons. They register the beacons and can report about received identifiers, preferably with a distance indication, e.g., RSSI or distance class etc. This reduces the amount of manual work in commissioning. In fact, at least for an initial commissioning, no local presence is required for commissioning.

For example, in an embodiment map storage 136 comprising a digital plan of the building automation system, the digital plan comprising the location of multiple control areas. Control areas are often the same as rooms, but this is not necessary. For example, a larger open office space, may be divided into multiple control areas. This has the effect that part of the open office need not be lighted if no one is using that part of the open office. Especially late at night such a partition can reduce energy use of the system—if only a few solitary persons remain working, only part of the lights need be on. For example, a room may be divided in a control area before a white-board and the rest of the room, etc.

In general, control areas refer to areas in which building automation devices are controlled together. For example, luminaires in a control area may be controlled the same, e.g., all on or off or dimmed together, etc. The control areas may be explicitly indicated in the digital plan, for example, as a polygon, etc. The control areas may also be inferred, e.g., by a rule that selects control areas on the basis of map features. For example, the digital plan may comprise structural building elements, such as wall, elevators, stairs, and the like. A rule may assign a room to be a control area. For example, a room smaller than a certain size. For example, a room larger than a certain size may automatically be divided into multiple control areas.

In the example, of FIG. 5, there are two control areas, corresponding to rooms 510 and 520. This may be indicated explicitly in the digital plan, but may also be inferred from the walls shown.

As above, the commissioning device receives beacon messages from the building automation devices. In this example, four beacon messages are received. Localizing unit 152 is configured to establish an estimated location for each of the beacon messages. The estimated locations are indicated in FIGS. 5: 512, 522, 524, and 526.

In this case, matching unit 153 is configured to match the estimated location of the building automation device with a control area of the multiple control areas. For example, an estimated location may be matched with a control area if most of the estimated location is in the control area. For example, an estimated location may be matched with a control area if a center point of the estimated location falls in the control area, etc. In the situation shown in FIG. 5, the estimated location 512 is assigned to control area 510, whereas estimated locations 522, 524 and 526 are assigned to control area 520. For example, the corresponding network addresses may be associated to a control area.

Matching unit 153 assigns the matched building automation device to a group of building automation devices associated with the control area. In this case, two groups are formed, one corresponding to building automation devices with estimated locations 522, 524 and 526, we may refer to this group as group I, the other corresponding to the building automation device with estimated location 512, we may refer to this group as group II. With at least one control group one or more control rules are associated. For example, the commissioning device may comprise a user interface that allows a user to assign a rule to the control group. Once a rule has been associated with a control group, the commissioning device may proceed as above, and, e.g., upload the rule to the trigger, or load device and/or to a control computer.

In an embodiment, a rule is automatically selected and associated to a control group. For example, a rule database 137 may comprise a rule database comprising one or more template rules, a template rule indicating a status change for a load device of a particular load type in dependence on a trigger signal of a trigger device of a particular trigger type.

For example, a template rule may apply to the devices in a control group. For example, a template rule may be that if a group comprises a flip switch then all luminaire in the same control group should switch. For example, a template may be that luminaires should switch on if an occupancy sensor in the group detects occupancy, e.g., for at least x seconds.

In an embodiment, the processor circuit may be configured to

determine that network addresses are available for load devices and trigger devices in the same control area. For example, the processor circuit may assign a control group as described above.

determine the load device types and trigger device types in the control area. For example, the types of the building automation device may be communicated in the beacon messages.

determine that a template rule matches the load device types and trigger device types in the control area. For example, a template rule may require a flip switch and one or more luminaires.

generate a rule for the load device identifiers and trigger device identifiers in the control area based on the template rule. For example, a rule may be produced form a template rule by substituting building automation device identifiers and/or network addresses.

The commissioning device may store the generated rule in the rule database.

This embodiment may also be used to commission new devices into an existing connected building automation system. For example, suppose a new switch is installed, say switch 3 in FIG. 2b. The switch reports the beacon identifiers received together with a distance indication, e.g., RSSI, or a distance class etc. For example, in the sketched example one beacon may be in the near class, whereas a next beacon is in the far class. Probably all other beacons that can be received at all, are in the far class.

In an embodiment, a scan of an office map is sent to a commissioning device, and a connected lighting system in installed in the building. The commissioning device uses the office map to identify walls and rooms, and defines control areas based on the identified rooms. When the connected lighting system is turned on, the building automation devices send a beacon message. The commissioning devices uses beacon based a localization service to localize the building automation device and assign each to a control group for a control area. Next default rules are assigned to the control groups. For example, each wall switch in a control group switches all luminaires in the same group. For example, each occupancy sensor in a control group switches all luminaires in the same group on, for at least 1 minute.

Thus as discussed, in different embodiment, the digital plan may differ. For example, in an embodiment, the digital plan comprises location of building automation device. For example, in an embodiment, the digital plan comprises the location of beacons. For example, in an embodiment, the digital plan comprises the location of structural building elements, such as walls. For example, in an embodiment, the digital plan comprises the location control areas. The different options can be combined. For example, in an embodiment, the digital plan comprises the location of building automation devices, beacons, and structural building elements, see for example, FIG. 2a.

In an embodiment, a building automation device may be a luminaire. In an embodiment, the building automation device is any one of the following group: a heating device, a ventilation device, an air conditioning device, a speaker, an automated air valve, a fire detector, an occupancy sensor, a day light sensor, a wall switch.

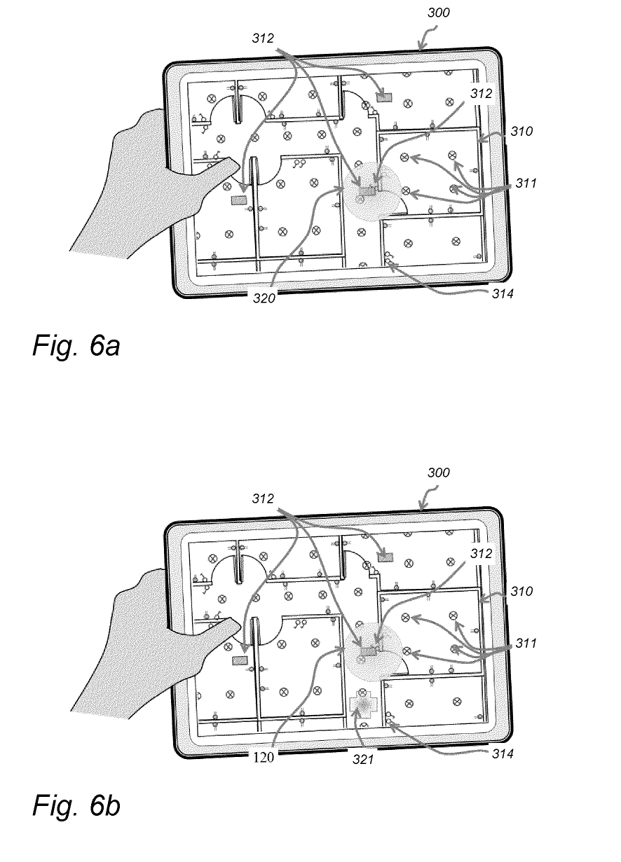

In an embodiment, the commissioning person is walking through the rooms where new devices need commissioning and makes use of beacons receivable by the lighting devices as well as a mobile commissioning device he is carrying. A user interface for a handheld commissioning tool is described below. The ratio of received beacons, or the like, is used to calculate an estimate location, say a location probability, which can be shown in a computer based commissioning tool. An exemplarily commissioning tool is depicted in FIG. 6a, running on a tablet computer.

Shown in FIG. 6a is the handheld computer device 300. The picture shown in the UI is the building plan 310. The lighting assets as planned for installation are contains as there are light sources 311, manual UI devices like switches 314 and the location of PSE devices 312. Power Sourcing Equipment (PSE) supports Power over Ethernet by sourcing power to PoE building automation devices over Ethernet cables.

The just installed manual switch 324 has provided beacon identifiers in a beacon message, from which the localization bubble 320 has been calculated which allows the operator to decide which device it is and commission it to the related group of light sources. For example, the commissioning tool automatically suggest an assignment to a control group of light sources, which the operator can confirm or reject. The commissioning tool may also be configured to automatically assign a device to a control group, which the operator may correct afterwards, if needed.

In embodiment, the commissioning person may be walking through the rooms where new devices need commissioning and makes use of beacons receivable for lighting devices as well as the mobile commissioning device he is carrying. In such a case the UI on the handheld computer can in addition show the current position 321 the commissioning person is. This is illustrated in FIG. 6b. This may be accomplished by receiving the beacons with a beacon receiver integrated with the handheld commissioning device.

In a further developed embodiment, localization may even be possible without using fully connected lighting network. For example, if the devices are able to report the received beacons using local wireless transmission, e.g. by means of Bluetooth, to the commissioning tool which then has to be in the vicinity of the device that needs to be commissioned. In another embodiment the beacons are only tools for the commissioning phase. They may, e.g., be de-mounted after commissioning is completed and inspectors have checked the lighting installation. In an embodiment the beacon transmitters are connected to and powered from luminaires. In an embodiment, a beacon is integrated with a PSE in one housing and/or be powered by PoE. In a beneficial embodiment, the PSE can report the beacon identifier of its own beacon.

In general, an input interface may take various forms, such as a network interface to a local or wide area network, e.g., the Internet, a storage interface to an internal or external data storage, etc.

Typically, the devices 110, 120, 130, and 130′ each comprise a microprocessor (not separately shown) which executes appropriate software stored at the device; for example, that software may have been downloaded and/or stored in a corresponding memory, e.g., a volatile memory such as RAM or a non-volatile memory such as Flash (not separately shown). The devices 110, 120, 130, and 130′ may, in whole or in part, be implemented in programmable logic, e.g., as field-programmable gate array (FPGA). Devices 110, 120, 130, and 130′ may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

In an embodiment, device 130 or 130′ comprises a localizing unit circuit and a matching unit circuit. The device 130 and 130′ may comprise additional circuits. The circuits implement the corresponding units described herein. The circuits may be a processor circuit and storage circuit, the processor circuit executing instructions represented electronically in the storage circuits. The circuits may also be, FPGA, ASIC or the like. The circuits implementing the corresponding units described herein.

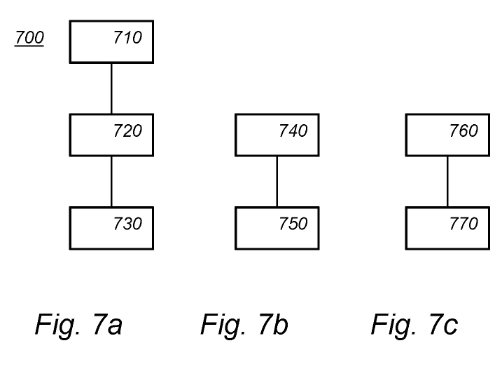

FIG. 7a schematically shows an example of an embodiment of a commissioning method 700. Method 700 comprises

communicating 710 with multiple electronic building automation devices over the digital network, and receiving a beacon message comprising localizing information based on the beacon identifiers received by the building automation device, together with a network address identifying the building automation device in the digital network. For example, the beacon message may be sent by the building automation devices directly to the commissioning device, e.g., to a pre-configured network address. For example, the beacon message may be broadcast. For example, the beacon message may be pulled, e.g., requested by the commissioning device.

localizing 720 a building automation device using the localization information in a beacon message received from the building automation device to obtain an estimated location of the building automation device,

commissioning 730 the building automation device in the building automation system.

FIG. 7b schematically shows an example of an embodiment of commissioning 730. For example, commissioning 730 may comprise

matching 740 the estimated location of the building automation device with a stored location in the digital plan of the building automation system, the digital plan comprising multiple building automation device identifiers corresponding to the multiple building automation devices and a corresponding location,

associating 750 the building automation device identifier corresponding to the stored location with a network address received from the building automation device with the beacon message.

Once a building automation device in the field has been associated with a building automation device in the plan, e.g., as above, the building automation device may be assigned to a group of building automation devices associated with a control area, e.g., as indicated in the plan. Assigning building automation devices to a control group may also be done without having location of the building automation devices in the plan. This is convenient, e.g., if a map of the building is available and may be used to indicate control areas, but no map is available with the locations of the building automation device.

FIG. 7c schematically shows an example of an embodiment of commissioning 730. For example, commissioning 730 may comprise

matching 760 the estimated location of the building automation device with a control area of the multiple control areas, a digital plan comprising the location of multiple control areas,

assigning 770 building automation devices matched to the same control area to at least one group of building automation devices associated with the control area.

After assigning a building automation device to a control group, the method may further comprise associating 780 one or more control rules to the group of building automation devices.

Method 700 may comprise elements 740 and 750 and/or elements 760 and 770.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. Moreover, a given step may not have finished completely before a next step is started.

A method according to the invention may be executed using software, which comprises instructions for causing a processor system to perform method 700. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

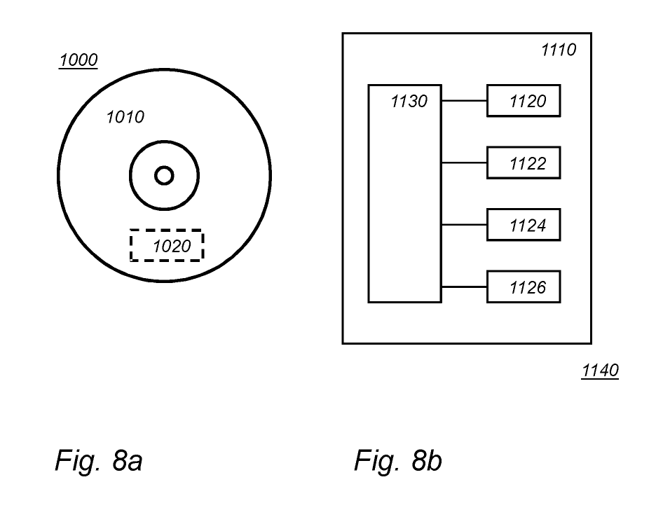

FIG. 8a shows a computer readable medium 1000 having a writable part 1010 comprising a computer program 1020, the computer program 1020 comprising instructions for causing a processor system to perform a commissioning method, according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said commissioning method.

FIG. 8b shows in a schematic representation of a processor system 1140 according to an embodiment. The processor system comprises one or more integrated circuits 1110. The architecture of the one or more integrated circuits 1110 is schematically shown in FIG. 8b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, the commissioning device may comprise a processor circuit and a memory circuit, the processor being arranged to execute software stored in the memory circuit. For example, the processor circuit may be an Intel Core i7 processor, ARM Cortex-R8, etc. The memory circuit may be an ROM circuit, or a non-volatile memory, e.g., a flash memory. The memory circuit may be a volatile memory, e.g., an SRAM memory. In the latter case, the verification device may comprise a non-volatile software interface, e.g., a hard drive, a network interface, etc., arranged for providing the software.

The following clauses are related to embodiments. Divisionals may be filed based on the clauses, possibly combined with other parts of the description.

Clause 1. An electronic building automation system, comprising
(I) multiple electronic building automation devices (120), comprising

a communication interface (122) arranged to communicate with an external commissioning device over a digital network,

a beacon receiver (124) arranged to receive localizing beacon signals transmitted from multiple beacons installed in the vicinity of the multiple building automation devices, a localizing beacon signal comprising a beacon identifier identifying the beacon from which the localizing beacon signal originated,

a beacon identifier memory (126) for storing beacon identifiers received by the beacon receiver, and

a processor circuit (128) configured to
generate a beacon message comprising localizing information based on the beacon identifiers stored in the beacon identifier memory,
transmit the beacon message to the external commissioning device over the digital network together with a network address identifying the building automation device in the digital network, and
   (II) a commissioning device (130) comprising

a communication interface (132) arranged to communicate with the multiple electronic building automation devices over the digital network, and receive a beacon message comprising localizing information based on the beacon identifiers received by the building automation device, together with a network address identifying the building automation device in the digital network, and

a processor circuit (134) configured to
localize a building automation device using the localization information in a beacon message received from the building automation device to obtain an estimated location of the building automation device to commission the building automation device in the building automation system.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of embodiments or to formulas of embodiments, thus increasing the intelligibility of the claim. These references shall not be construed as limiting the claim.

1. An electronic building automation system, comprising
(I) multiple electronic building automation devices, each comprising
a communication interface arranged to communicate with commissioning device over a digital network,
a beacon receiver arranged to receive localizing beacon signals transmitted from multiple beacons installed in the vicinity of the multiple building automation devices, each of the localizing beacon signals comprising a beacon identifier identifying the beacon from which the localizing beacon signal originated,
a beacon identifier memory for storing beacon identifiers received by the beacon receiver, and
a processor circuit configured to
generate a beacon message comprising localizing information based on the beacon identifiers stored in the beacon identifier memory,
transmit the beacon message to the commissioning device over the digital network together with a network address identifying the building automation device in the digital network, and
(II) the commissioning device comprising
a communication interface arranged to communicate with the multiple electronic building automation devices over the digital network, and receive the beacon messages, together with the network address identifying the building automation device in the digital network,
a map storage comprising a digital plan of the building automation system, the digital plan comprising the location of multiple control areas, and
a processor circuit configured to
localize the building automation device using the localization information in the beacon message received from the building automation device to obtain an estimated location of the building automation device to commission the building automation device in the building automation system, wherein the location of building automation device is estimated as an area, constructed by an intersection of areas where the beacon messages are received; and
wherein the processor circuit is configured to
match the estimated location of the building automation device with a control area of the multiple control areas,
assign the building automation device matched to the same control area to at least one group of building automation devices associated with the control area.

2. An electronic building automation system as in claim 1, wherein
the building automation system is a connected lighting system, the multiple building automation devices including at least one or more luminaires, and/or
the building automation system is a connected HVAC system, the multiple building automation devices including at least one or more heating, ventilation and/or air conditioning device.

3. (canceled)

4. A commissioning device as in claim 1, wherein
the digital plan comprises multiple building automation device identifiers corresponding to the multiple building automation devices and a corresponding location, wherein
the processor circuit is configured to
match the estimated location of the building automation device with a corresponding location in the digital plan, and associate the building automation device identifier corresponding to the stored location with the network address received from the building automation device with the beacon message.

5. A commissioning device as in claim 1, wherein the commissioning device comprises an addressing storage storing an addressing table associating multiple building automation device identifiers and the associated network addresses of building automation devices, and wherein the processor circuit is configured to
match the estimated location of the building automation device with a stored location in the digital plan for which the corresponding building automation device identifier is not yet associated with a network address in the addressing table.

6. A commissioning device as in claim 1, wherein the beacon message comprises a building automation device type of the originating building automation device, furthermore the digital plan comprising multiple building automation device types associated with the multiple building automation device identifiers, the processor circuit is configured to
match the estimated location of the building automation device with a stored location in the digital plan for which the building automation device type associated with the corresponding building automation device identifier matches the building automation device type in the received beacon message.

7. A commissioning device as in claim 1, wherein the digital plan does not contain the location of any of building automation devices, the processor circuit being configured to identify walls and rooms in the digital plan, and to define control areas based on the identified rooms.

8. A commissioning device as in claim 1, the multiple building automation devices comprising load devices and trigger devices, the commissioning device comprising
a rule database comprising one or more rules, a rule indicating a status change for a load device in dependence on a trigger signal of a trigger device, wherein the processor circuit is configured to
identify a rule in the rule database applicable to a load and/or trigger device for which a network address has been received,
the processor circuit being configured to send the rule to the load device and/or the trigger device, and/or a control device different from the load device and trigger device.

9. A commissioning device as in claim 1, the multiple building automation devices comprising load devices and trigger devices,
a rule database comprising one or more rules, a rule indicating a status change for a load device with a load identifier in dependence on a trigger signal of a trigger device with a trigger identifier,
the processor circuit being configured to
receive one or more a trigger signals of a trigger device,
determine that a rule in the rule database indicates a status change for a load device with a load identifier in dependence on the received trigger signals
determine the network address for the load identifier from the addressing table,
sent a command message to effect the status change for the load device to the network address determined for the load device identifier.

10. A commissioning device as in claim 1, the multiple building automation devices comprising load devices and trigger devices, the digital plan indicating control areas,
a rule database comprising one or more template rules, a template rule indicating a status change for a load device of a particular load type in dependence on a trigger signal of a trigger device of a particular trigger type,
the processor circuit being configured to
determine that network addresses are available for load devices and trigger devices in the same control area,
determine the load device types and trigger device types in the control area,
determine that a template rule matches the load device types and trigger device types in the control area,
generate a rule for the load device identifiers and trigger device identifiers in the control area based on the template rule
store the generated rule in the rule database.

11. A commissioning device as in claim 10, wherein the building automation device is a luminaire, or wherein the building automation device is any one of the following group: a heating device, a ventilation device, an air conditioning device, a speaker, an automated air valve, a fire detector, an occupancy sensor, a day light sensor, a wall switch.

12. A commissioning method comprising
communicating by a commissioning device with multiple electronic building automation devices over a digital network, and receiving beacon messages comprising localizing information based on beacon identifiers received by the building automation device, together with a network address identifying the building automation device in the digital network, and
localizing by the commissioning device a building automation device using the localization information in the beacon message received from the building automation device to obtain an estimated location of the building automation device, and commissioning the building automation device in the building automation system, wherein the location of building automation device is estimated as an area, constructed by an intersection of areas where the beacon messages are received,
matching by a commissioning device the estimated location of the building automation device with a control area of multiple control areas,
assigning by a commissioning device building automation device matched to the same control area to at least one group of building automation devices associated with the control area.

13. A commissioning method as in claim 12, comprising
matching the estimated location of the building automation device with a stored location in a digital plan of the building automation system, the digital plan comprising multiple building automation device identifiers corresponding to the multiple building automation devices and a corresponding location,
associating the building automation device identifier corresponding to the stored location with a network address received from the building automation device with the beacon message.

14. A commissioning method as in claim 12, comprising
matching the estimated location of the building automation device with a control area of the multiple control areas, a digital plan comprising the location of multiple control areas,
assigning building automation devices matched to the same control area to at least one group of building automation devices associated with the control area,
associating one or more control rules to the group of building automation devices.

15. A computer readable medium comprising transitory or non-transitory data representing instructions to cause a processor system to perform the method according to claim 12.
